(19) United States
(12) Patent Application Publication
(10) Pub. No.: US 2007/0240720 A1
(43) Pub. Date: Oct. 18, 2007

(54) Supplemental passenger oxygen mask

(76) Inventor: Valentin A. Castro, Williamsville, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 11/728,101

(22) Filed: Mar. 23, 2007

Related U.S. Application Data
(60) Provisional application No. 60/785,038, filed on Mar. 23, 2006.

(51) Int. Cl. A62B 18/02; A62B 23/02

(52) U.S. Cl. 128/206.12; 128/205.25; 128/206.21; 128/206.28; 128/205.27

(57) ABSTRACT

A face piece/reservoir combination that is molded as one piece. By integrating the face piece and reservoir bag into one single piece, the mask conserves space and reduces the number of parts while maintaining adequate reservoir volume. The mask has an edge on the face cup that provides a larger sealing area for the users face and provides a more comfortable fit than existing masks. The mask may be configured as a simple constant flow mask or it may include valves, allowing it to function as a phase dilution mask. The mask may be equipped with a rebreather bag and valves to function as a rebreather/phase dilution mask

### CROSS-REFERENCE TO RELATED APPLICATIONS

This application claims benefit of U.S. provisional patent application Ser. No. 60/785,038 filed Mar. 23, 2006, which is incorporated herein by reference.

### FIELD OF THE INVENTION

This invention relates to a passenger oxygen dispensing unit of the type used on aircraft with pressurized cabins by passengers during decompression emergencies to provide supplemental oxygen.

### BACKGROUND OF THE INVENTION

Modern pressurized passenger aircraft fly at altitudes in the range of 18,000 to 40,000 feet. At these altitudes the air is at a reduced density because the atmospheric pressure is much lower than at sea level. Thus, the partial pressure of oxygen in the air is not sufficient to sustain normal respiration. Consequently, there has been a need for a system to supply additional oxygen for the survival of passengers in the event of a depressurization emergency of the airplane cabin.

In the prior art, especially in U.S. Pat. Nos. 4,098,271 and 4,832,017, there are shown emergency oxygen breathing apparatuses that include a facepiece having valves. The facepiece is designed to cover the nose and mouth of the user and is connected to an oxygen delivery tube. A bag which functions as a reservoir is connected between the facepiece and the delivery tube and the reservoir permits an efficient use of the limited oxygen supply. The masks are normally presented automatically on depressurization. For some masks, in order to activate the flow of oxygen, the facepiece and bag assembly are typically pulled down by the passenger.

What is needed is a supplemental passenger oxygen mask that conserves space, reduces the number of parts while maintaining adequate reservoir volume, and provides a more comfortable fit.

### SUMMARY OF THE INVENTION

The present invention meets the above-described need by providing a face piece/reservoir combination that is molded as one piece. By integrating the face piece and reservoir bag into one single piece, the mask conserves space and reduces the number of parts while maintaining adequate reservoir volume. The mask has an edge on the face cup that provides a larger sealing area for the users face and provides a more comfortable fit than existing masks. The mask may be configured as a simple constant flow mask or it may include valves, allowing it to function as a phase dilution mask. The mask may be equipped with a rebreather bag and valves to function as a rebreather/phase dilution mask.

### BRIEF DESCRIPTION OF THE DRAWINGS

The invention is illustrated in the drawings in which like reference characters designate the same or similar parts throughout the figures of which:

FIG. 1 is a perspective view of the supplemental passenger oxygen mask of the present invention;

FIG. 2 is a side elevation view of the mask shown in FIG. 1;

FIG. 3 is a cross-sectional view taken along lines 3-3 of FIG. 2;

FIG. 4 is a side elevation view of the body prior to forming the mask;

FIG. 5 is a cross-sectional view taken along lines 5-5 of FIG. 4;

FIG. 6 is a side elevational view of an alternate embodiment of the present invention; and,

FIG. 7 is a cross-sectional view taken along lines 7-7 of FIG. 6.

### DETAILED DESCRIPTION OF THE INVENTION

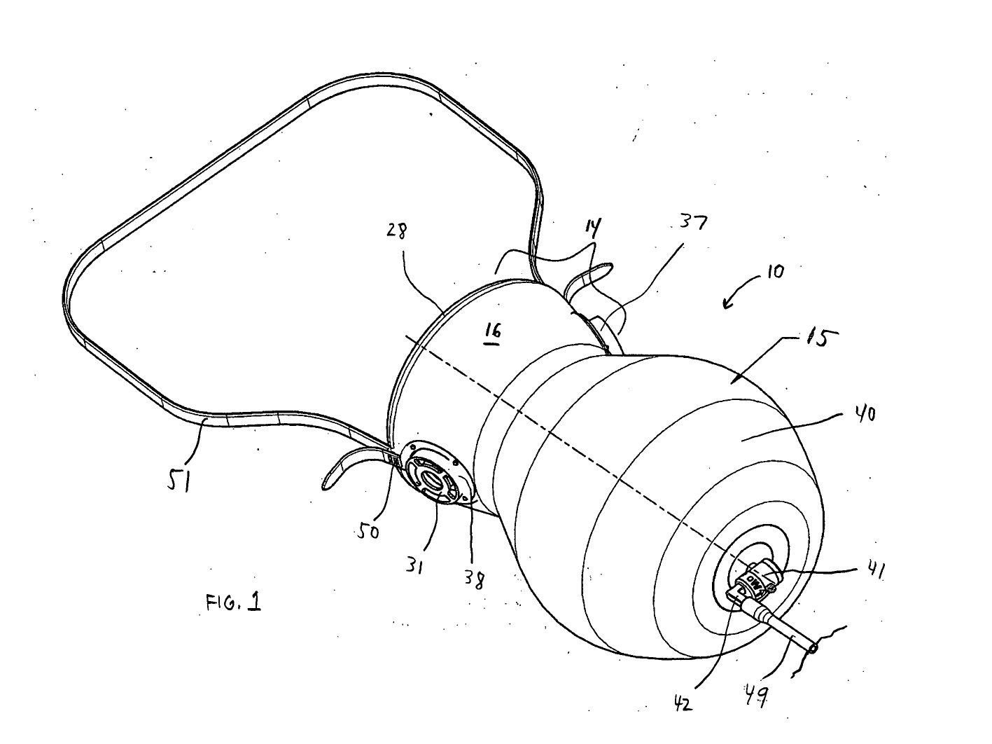

Referring generally to FIGS. 1-5 and initially to FIG. 1, a supplemental passenger oxygen mask 10 is formed by a unitary member that includes both a reservoir 40 and a cup-shaped mask portion 16. The reservoir 40 has a flow indicator 41 and an inlet 42 for attachment of a tube 49 that leads to an oxygen source. The oxygen source may comprise an oxygen cylinder, chemical oxygen generator, or the like. Actuation of the flow of oxygen may be accomplished in numerous ways as will be evident to those of ordinary skill in the art. The cup-shaped mask portion 16 has an edge 28 formed due to the fold that engages with the face of the user to form a seal during use. The sides of the cup-shaped mask portion 16 may be provided with an exhalation valve 31 and an ambient inhalation valve 37. Also, the valve housings 38 may be provided with an attachment member 50 for connecting a head harness 51 to the mask 10.

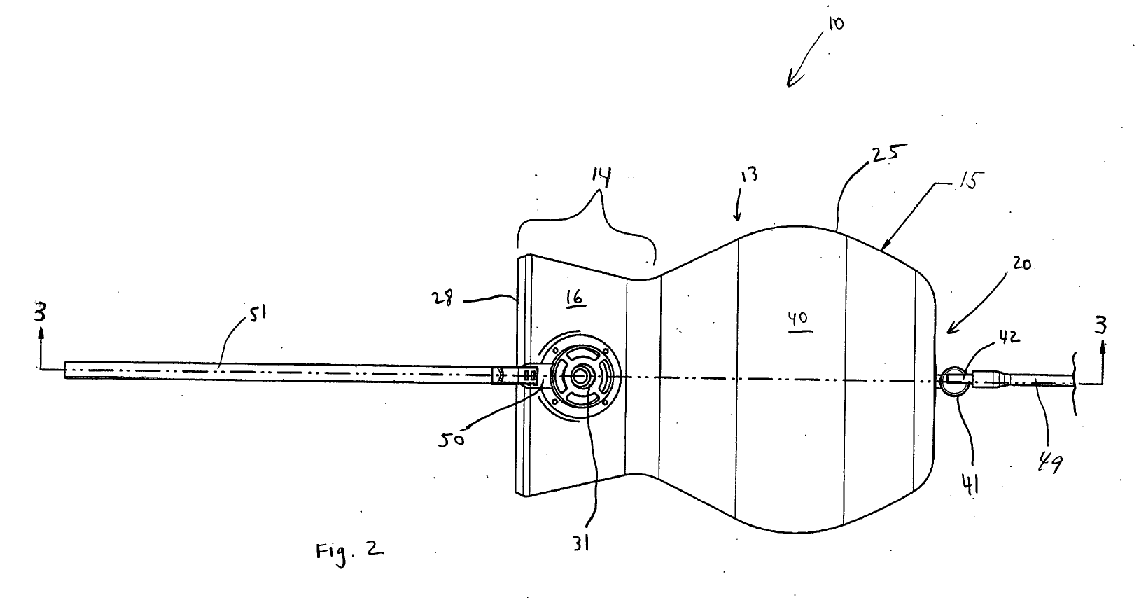

As shown in FIG. 2, the mask 10 may be provided with a relatively flat end 20 where the flow indicator and gas inlet are located. While in use, the reservoir 40 has a wall 25 that curves outward and then inward from the end 20 toward the mask portion 16. The wall 25 extends into the mask portion 16 where it is angled outward and terminates in an edge 28 formed by the fold. The edge 28 engages with the face of the user to form a seal. The head harness strap 51 connects to the attachment member 50. The head harness strap 51 may be formed out of a resilient flexible material. In use, the mask portion 16 is placed over the mouth and nose of the user and the head harness strap 51 is stretched around the head of the user to hold the mask 10 in position against the face of the user.

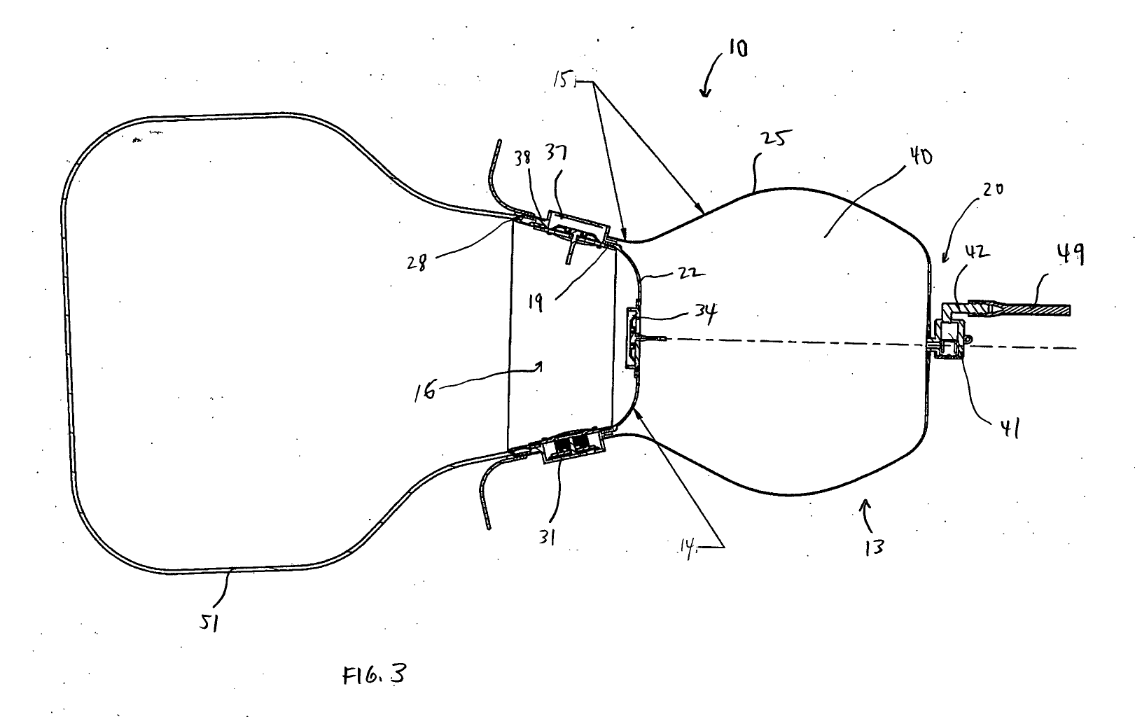

Turning to FIG. 3, an inverted end of the body 13 forms the cup-shaped mask portion 16. The cup-shaped portion 16 includes an end wall 22. The end wall 22 supports an inhalation check valve 34. The side wall 19 of cup-shaped portion 16 is disposed adjacent to the wall 25 of the body 13 to form a double walled area. Side wall 19 is attached to side wall 25 by means of valve housings 38 in the example shown. At the end of the cup-shaped portion 16, a folded over transition from the wall 19 to the wall 25 forms the edge 28 that contacts the face of the user. The edge forming the lip 28 and the choice of materials results in a more comfortable fit compared to prior art masks having separate reservoir bags and cup-shaped breathing masks constructed of relatively rigid plastic materials.

The mask 10 may be provided with three separate valves as shown in the figures. The valves include an exhalation valve 31, the inhalation check valve 34, and an ambient inhalation valve 37. The valve housings 38 contain valve flappers and springs (not shown). A mechanical flow indicator 41 may be attached to the base of the reservoir bag 40 which indicates when oxygen is flowing to the mask 10. Alternatively, an inflatable flow indicator option is also available. As will be evident to those of ordinary skill in the art, provisions for a lanyard for actuating flow when the mask 10 is pulled toward the face of the user can also be made with this design.

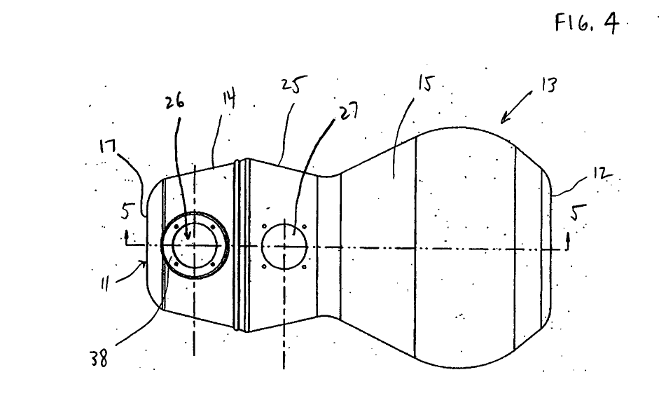

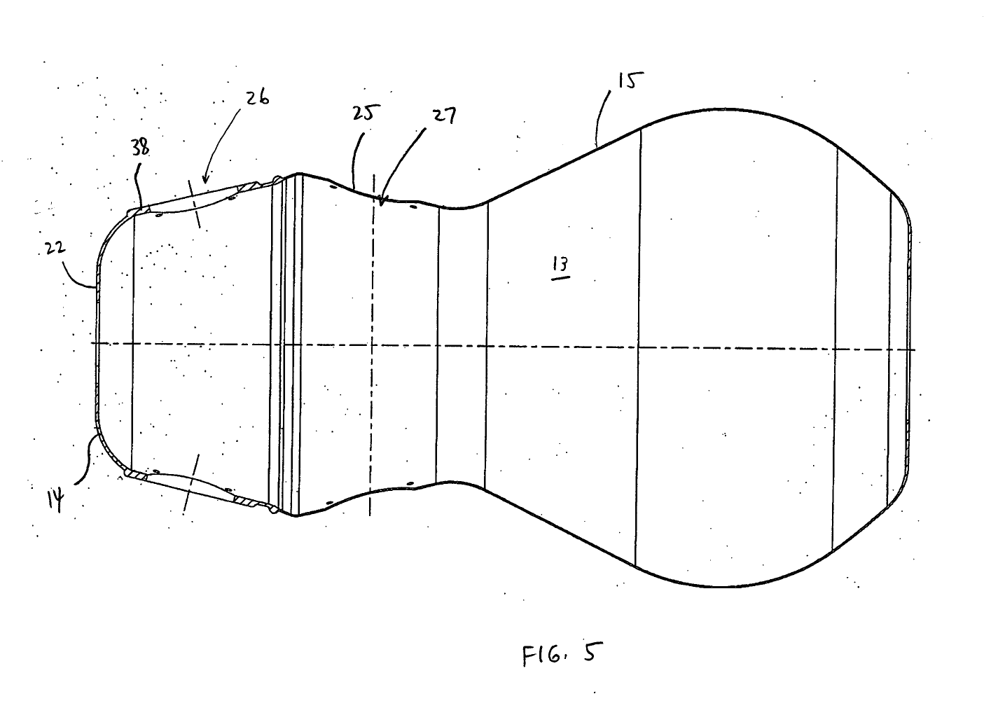

Referring to FIGS. 4-5, the mask 10 of the present invention may be formed from a unitary body of flexible material. For example, the mask 10 may be molded from a clear silicone material such as Baysilone LSR 2050, which is a liquid, injection moldable silicone available from GE Silicones, Waterford, New York. Other materials are also suitable as will be evident to those of ordinary skill in the art based on this disclosure. The mask body 13 may be initially formed in the shape of a hollow oblate spheroid. Oblate is defined herein as flattened or depressed at the poles 11, 12. Spheroid is defined herein as a figure resembling a sphere where sphere is defined as a body whose major circumferences approximate to circles. The body 13 may be provided with a thicker section 14 and a thinner section 15 to improve flexibility. Alternatively, the body 13 may be constructed of uniform thickness throughout. Other hollow elongate shapes are also suitable as will be evident to those of ordinary skill in the art based on this disclosure. After the body 13 is initially formed, the cup portion 16 may be formed by pushing one end 17 (i.e., the short radius end) of the body 13 inward to form walls 19 and 22 (FIG. 3) and attaching the inward folded wall 19 of the inverted portion to the wall 25 of the body 13. The mask body 13 is molded as one piece with openings 26, 27 for receiving valves 31 and 37, and head harness attachments 50. Openings 26, 27 are capable of aligning when the body 13 is inverted to form the cup-shaped portion 16. Valve housings 38 are installed in the aligned openings. The valve housings 38 extend through the walls 19 and 25 and secure the walls 19, 25 together to fix the cup-shaped portion 16 and a reservoir 40 formed by the remaining portion of the body 13.

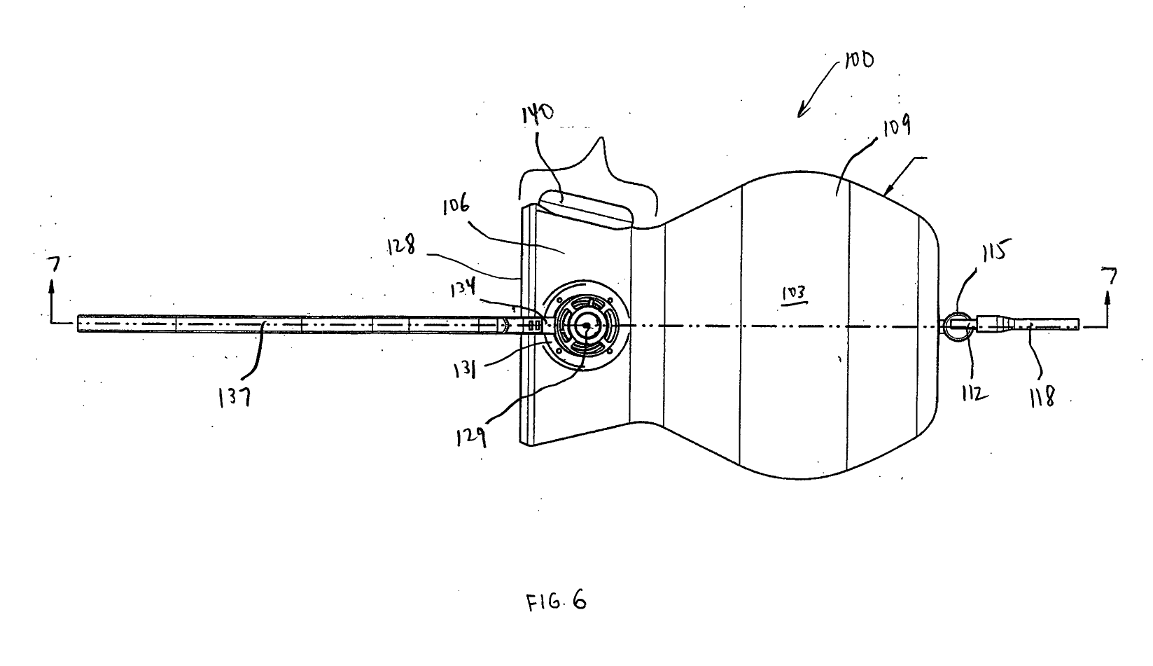

Turning to FIG. 6, a rebreather/phase dilution type mask 100 has a body 103 similar to the mask 10 shown in FIGS. 1-3. The body 103 may be constructed of a material having uniform thickness or the body 103 may include a thinner wall section 104 and a thicker wall section 105. In order to recycle a portion of exhaled air, the mask 100 includes a rebreather bag and an additional valve as described in detail below. The mask 100 also includes a cup-like mask portion 106 and a reservoir section 109. The reservoir section 109 has an inlet 112 with a flow indicator 115 and a tube 118 leading to an oxygen source.

The mask portion 106 terminates at an edge 128. An ambient exhalation valve 129 is disposed in a valve housing 131. The valve housing 131 includes an attachment member 134 for connecting the mask 100 to a head harness 137. The mask 100 includes a reservoir inhalation valve 140.

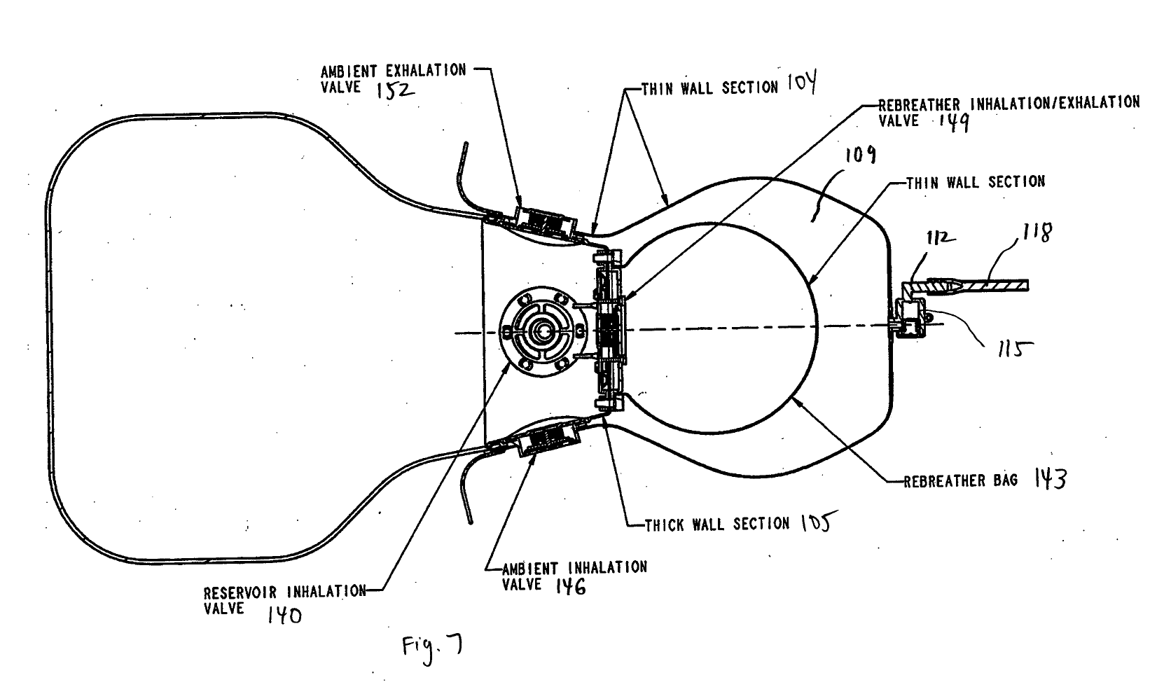

Turning to FIG. 7, the rebreather passenger mask assembly functions as a hybrid version of current reservoir bag passenger masks. Metered oxygen flows through the tube 118 into reservoir section 109. Oxygen flow is indicated by the flow indicator 115 located at the base of the reservoir section 109. During inhalation, oxygen is drawn from the reservoir section 109 through the reservoir inhalation valve 140. When the oxygen in the reservoir section 109 is depleted, a spring loaded flapper in a rebreather inhalation valve 149 opens which allows exhaled air from a separate rebreather bag 143 to be inhaled. When the rebreather bag 143 is also depleted, the ambient inhalation valve 146 opens to allow ambient air (i.e., cabin air) to enter the mask portion 106. Both the ambient inhalation valve 146 and the reservoir inhalation valve 140 employ specially sized springs to prevent the valves from opening out of sequence. When the user exhales, the inhalation valves 140, 149 and ambient air valve 146 close and the rebreather exhalation valve 149 opens allowing the initial slug of exhaled air to empty into the rebreather bag 143. When the rebreather bag 143 is full, the ambient exhalation valve 152 opens to allow the rest of the exhalation to empty into the ambient air. This valve 152 also employs a specially sized spring to allow the valve to open at the proper point in the breathing cycle. The object of the rebreather bag 143 is to capture the first portion of the exhalation which is rich in oxygen content and relatively low in carbon dioxide. This first portion of the exhalation corresponds to the gas that remains in the airways of the upper respiratory tract and in areas external to the user that do not reach the gas exchange zones of the lungs.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

What is claimed is:

1. A combination breathing mask and reservoir assembly, comprising:
a unitary hollow member having a first end wall, a second end wall and at least one side wall, the first end wall having an inside surface and an outside surface and capable of being inverted such that the outside surface forms a cup-shaped mask portion bordered by an edge of the at least one sidewall, the inverted end wall dividing the mask portion from a cavity bordered by the second end wall, the at least one side wall and the inside surface of the first end wall, the cavity forming a reservoir;
an inlet disposed on the reservoir;
at least one inlet disposed in fluid communication between the reservoir and the mask portion; and,
at least one outlet disposed on the mask portion.

2. The breathing mask and reservoir assembly of claim 1, wherein the mask portion has a side wall portion extending between the first end wall and the edge.

3. The breathing mask and reservoir assembly of claim 2, wherein the side wall portion has an opening defined therein.

4. The breathing mask and reservoir assembly of claim 3, wherein the opening in the side wall portion is aligned with an opening in the at least one side wall.

5. The breathing mask and reservoir assembly of claim 4, wherein at least one valve assembly is disposed in the aligned openings such that the valve assembly attaches the mask portion to the at least one side wall to form the cavity.

6. The breathing mask and reservoir assembly of claim 1, further comprising an anti-suffocation valve disposed in the mask portion.

7. The breathing mask and reservoir assembly of claim 1, wherein the inlet to the reservoir is disposed on the second end wall.

8. The breathing mask and reservoir assembly of claim 1, wherein the inlet that is disposed in fluid communication between the mask portion and the reservoir is disposed on the first end wall.

9. The breathing mask and reservoir assembly of claim 1, further comprising a head strap attached to the mask portion.

10. The breathing mask and reservoir assembly of claim 1, wherein the outlet valve and the anti-suffocation valve are disposed in aligned openings formed in a side wall of the mask portion and the at least one side wall.

11. The breathing mask and reservoir assembly of claim 1, further comprising: at least one rebreather bag disposed inside the reservoir and disposed in fluid communication with the mask portion.

12. A combination breathing mask and reservoir assembly, comprising:
a unitary hollow member having a first end wall, a second end wall and at least one side wall, the first end wall having an inside surface and an outside surface and capable of being inverted such that the outside surface forms a cup-shaped mask portion bordered by an edge of the at least one sidewall, the inverted end wall dividing the mask portion from a cavity bordered by the second end wall, the at least one side wall and the inside surface of the first end wall, the cavity forming a reservoir;
an inlet disposed on the reservoir;
at least one inlet disposed in fluid communication between the reservoir and the mask portion;
at least one outlet disposed on the mask portion; and,
a rebreather bag disposed in fluid communication with the mask portion.

13. The combination breathing mask and reservoir assembly of claim 12, wherein the rebreather bag is disposed inside the reservoir.

14. The breathing mask and reservoir assembly of claim 13, wherein the mask portion has a side wall portion extending between the first end wall and the edge.

15. The breathing mask and reservoir assembly of claim 14, wherein the side wall portion has an opening defined therein.

16. The breathing mask and reservoir assembly of claim 15, wherein the opening in the side wall portion is aligned with an opening in the at least one side wall.

17. The breathing mask and reservoir assembly of claim 16, wherein at least one valve assembly is disposed in the aligned openings such that the valve assembly attaches the mask portion to the at least one side wall to form the cavity.

18. The breathing mask and reservoir assembly of claim 12, further comprising an anti-suffocation valve disposed in the mask portion.

19. The breathing mask and reservoir assembly of claim 12, wherein the inlet to the reservoir is disposed on the second end wall.

20. The breathing mask and reservoir assembly of claim 12, wherein the inlet disposed in fluid communication between the mask portion and the reservoir is disposed on the first end wall.

21. The breathing mask and reservoir assembly of claim 12, further comprising a head strap attached to the mask portion.

22. A method of forming a combination mask and reservoir assembly, comprising:
forming a unitary hollow member having a first end wall, a second end wall disposed opposite from the first end wall, and at least one side wall disposed between the first end wall and the second end wall, the first end wall having an inside surface and an outside surface;
inverting the first end wall to form a cup-shaped mask portion bordered by an edge of the at least one side wall;
attaching the mask portion to the at least one side wall such that a cavity is formed, the cavity bordered by the inside surface of the first end wall, the at least one side wall and the second end wall, the cavity forming a reservoir;
forming an inlet in the reservoir;
forming an inlet disposed in fluid communication between the mask portion and the reservoir; and,
forming an outlet in the mask portion.
